(19) United States
(12) Patent Application Publication
(10) Pub. No.: US 2024/0011615 A1
(43) Pub. Date: Jan. 11, 2024

(54) Lighting Apparatus for a Motor Vehicle Headlamp of a Single-Track Motor Vehicle

(71) Applicant: ZKW Group GmbH, Wieselburg (AT)

(72) Inventors: Michael BÖLLMANN, Holzkirchen (DE); Martin JANTSCHEK, Mammendorf (DE); Nina BRAUNER, Altlengbach (DE); Marina FISCHER, Wieselburg (AT); Jaroslav KYSELICA, De{hacek over (z)}erice (SK); Anton KOKO{hacek over (S)}KA, Zázrivá (SK)

(21) Appl. No.: 18/034,992

(22) PCT Filed: Oct. 29, 2021
(86) PCT No.: PCT/EP2021/080132

§ 371 Date: May 2, 2023

(30) Foreign Application Priority Data
Nov. 17, 2020 (EP) 20208068.5

(51) Int. Cl. F21S 41/663; F21S 41/24; F21S 41/25; F21S 41/143; B60Q 1/115

(52) U.S. Cl. CPC F21S 41/663; F21S 41/24; F21S 41/25; F21S 41/143; B60Q 1/115; B60Q 2300/136; F21W 2107/17

(57) ABSTRACT

Illumination device (10) for a motor vehicle headlight of a single-track motor vehicle for producing segmented light distribution, wherein the illumination device (10) comprises the following:
an optical element (100), comprising a base body (110) and a plurality of light guiding bodies (200) protruding from the base body (110), which light guiding bodies (200) respectively have a light entry surface (210) and an exit surface (220), wherein the exit surfaces (220) of adjacent light guiding bodies (200) form a common exit surface (220a) of the optical element (100),
a plurality of light sources (50),
projection optics (300) with an optical axis (A), wherein the base body (110) has a first and a second light emission half (110a, 110b), wherein each light emission half (110a, 110b) has light guiding bodies (200), which are arranged at least in a first row (R1) along a straight line and in a second row (R2) along a straight line, wherein the straight lines of the first and the second row (R1, R2) are arranged relative to each other by a first angular offset (W1), and wherein the first and second light emission halves (110a, 110b) are arranged in mirror symmetry to one another about a vertical axis of symmetry (V) on the base body (110).

The invention relates to an illumination device for a motor vehicle headlight of a single-track motor vehicle for producing segmented light distribution, wherein the illumination device comprises the following:
an optical element, comprising a base body and a plurality of light guiding bodies protruding from the base body for forming definable segmented light distribution from the light of light sources, which light guiding bodies respectively have a light entry surface, into which light can be fed from the light sources, and an exit surface, from which light that can be fed into the respective light guiding body exits, wherein the exit surfaces of adjacent light guiding bodies form a common exit surface of the optical element,
a plurality of light sources, wherein at least one light source is respectively associated with an entry surface of a light guiding body,
projection optics with an optical axis, which projection optics are designed to project the light emitted from the common exit surface in front of the illumination device in the direction of a main emission direction.

Furthermore, the invention relates to a motor vehicle headlight having at least one illumination device according to the invention.

In order to improve the illumination of the driver's field of vision when a single-track motor vehicle, for example a motorbike, is cornering, additional light segments are switched on depending on the cornering position.

In the prior art, this has previously been achieved by means of additional reflectors and/or light modules.

However, these additional modules require a lot of installation space, wherein these additional modules also have to be adjusted to each other in advance, which entails additional effort.

It is an object of the invention to provide an improved illumination device.

This object is achieved by virtue of the fact that the base body has a first and a second light emission half, wherein each light emission half has light guiding bodies, which are arranged at least in a first row along a straight line and in a second row along a straight line, wherein the straight lines of the first and the second row are arranged relative to each other by a first angular offset, and wherein the first and second light emission halves are arranged in mirror symmetry to one another about a vertical axis of symmetry on the base body.

It can be provided that the exit surfaces of adjacent light guiding bodies in one row are directly adjacent to each other such that there is no gap between the exit surfaces.

It can be provided that the exit surfaces of adjacent light guiding bodies in different rows are directly adjacent to each other such that there is no gap between the exit surfaces.

It can be provided that the exit surfaces of the light guiding bodies of one row get bigger starting from the vertical axis of symmetry.

It can be provided that the entry surfaces of the light guiding bodies are arranged in a common vertical plane, which vertical plane is arranged orthogonal to the optical axis of the projection optics.

It can be provided that the light sources are light-emitting diodes.

It can be provided that the light-emitting diodes can be controlled independently of one another.

It can be provided that the common exit surface of the optical element is curved.

It can be provided that the projection optics have a curved focal surface, wherein the common exit surface of the optical element is arranged in the focal surface of the projection optics, wherein the common exit surface follows the curvature of the focal surface of the projection optics at least in sections. Here, the exit surface follows the curvature mainly in the central angular area of the focal surface, i.e. in an area close to the optical axis of the projection optics.

It can be provided that each light guiding body has side walls extending from the entry surface to the exit surface, wherein the exit surface is respectively delimited by two narrow sides and two long sides, wherein the side surfaces of at least one light guiding body, which side surfaces are orthogonal to a direction transverse to the main emission direction, are curved, wherein that side surface of the light guiding body that is directed towards the vertical axis of symmetry is convex, and that side surface of the light guiding body that is directed opposite to the vertical axis of symmetry is concave.

It can be provided that each row has an outermost light guiding body arranged away from the vertical axis of symmetry and at least one inner light guiding body, wherein the at least one inner light guiding body of each row has the curved side surfaces.

This counteracts the geometry of the Petzval surface of the projection lens and achieves a desirable intensity progression from the centre of the light distribution radially outwards along an oblique cut-off line of the segments as well as along a cut-off line that is oblique in a curved position.

It can be provided that the optical element comprises, in the area where the two light emission halves converge at the vertical axis of symmetry, at least one row having at least two light guiding bodies, wherein this row is arranged along a straight line, which is arranged orthogonal to the vertical axis of symmetry, wherein the optical element preferably comprises two rows.

This makes it possible for light to reach the area in front of the vehicle in full beam mode too and for a brightness minimum to be avoided if the segmented light distribution is intended as full beam distribution.

It can be provided that the entry surfaces of each light guiding body have a parallel offset from the corresponding exit surface such that the surface centres of the exit surface and the associated entry surface have an offset when viewed in the main emission direction.

This provision also serves to shift the focus of the light towards the centre of the light distribution in order to create homogeneous (continuous) light distribution that has a maximum in the centre.

It can be provided that the illumination device comprises a control unit and at least one roll angle sensor, which is designed to determine a roll angle of deviation of the actual position from a defined standard position of the illumination device about the main emission direction, wherein the control unit is designed to receive a role angle from the at least one roll angle sensor and switch on and/or off individual rows of the light guiding bodies depending on the roll angle.

It can be provided that when a first roll angle is detected, the control unit is designed to activate or switch on the first row of the first or second light emission half of the optical element, and wherein when a second roll angle is detected, the control unit is designed to activate or switch on the first and second row of the first or second light emission half of the optical element.

It can be provided that the optical element comprises a third row of light guiding bodies, which has a second angular offset from the first row and is arranged symmetrically about the vertical axis of symmetry, and wherein the optical element comprises a fourth row of light guiding bodies, which has a third angular offset from the first row and is arranged symmetrically about the vertical axis of symmetry.

It can be provided that when a third roll angle is detected, the control unit is designed to activate or switch on the first, second and third row of the first or second light emission half of the optical element, and wherein when a fourth roll angle is detected, the control unit is designed to activate or switch on the first, second, third and fourth row of the first or second light emission half of the optical element.

It can be provided that the first roll angle is in a range of 5° to 7°, the second roll angle is in a range of 7° to 17°, the third roll angle is in a range of 17° to 27° and the fourth roll angle is in a range over 27°.

It should be noted that the above angles are to be understood as absolute values and also include the negative angles, i.e. the range of the indicated roll angles is to be understood equally in a cornering position in the direction to the right as well as in the direction to the left.

It can be provided that the segmented light distribution is segmented full beam distribution.

The object is also achieved by a motor vehicle headlight having at least one illumination device according to the invention.

The invention is explained below in more detail based on exemplary drawings. In the drawings,

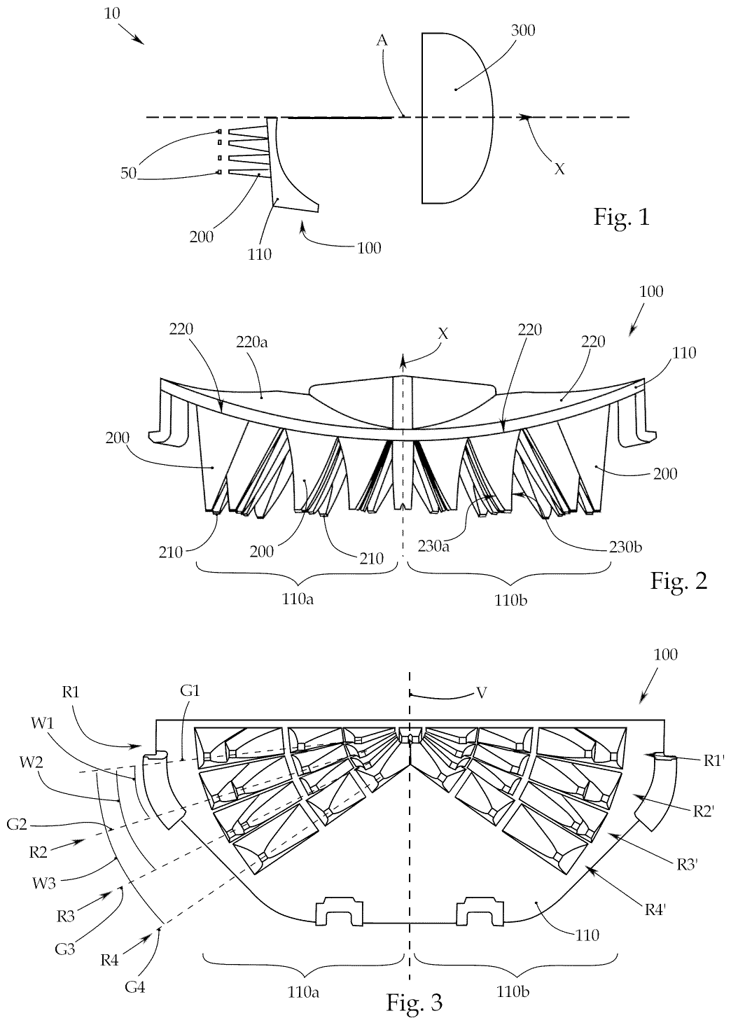

FIG. 1 shows an exemplary illumination device with an optical element and downstream projection optics,

FIG. 2 shows a view from above of the optical element of the illumination device from FIG. 1,

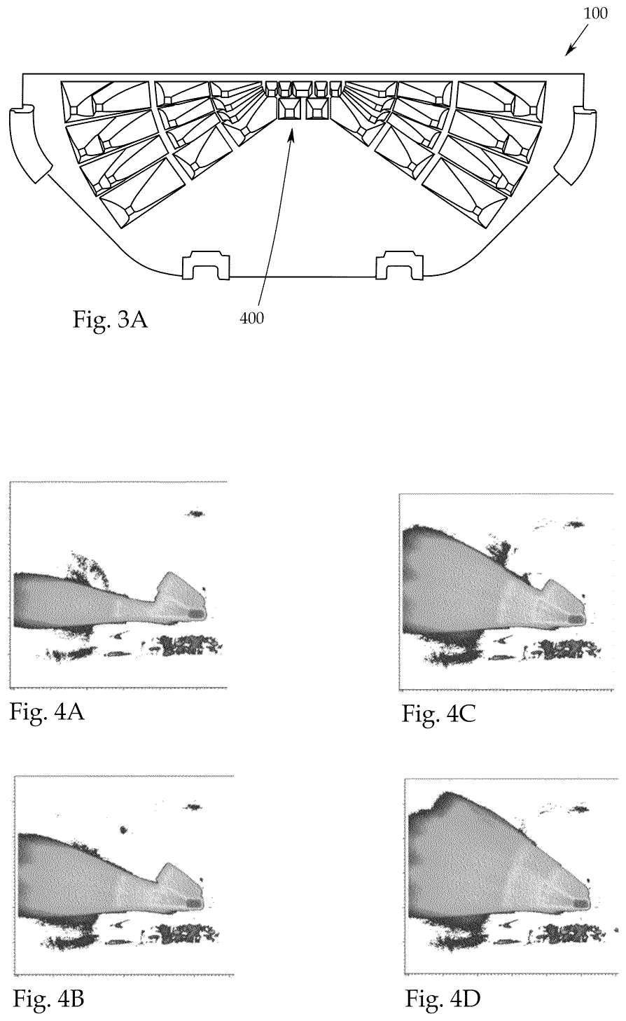

FIG. 3 shows a view from behind of the optical element from FIG. 2 with light guiding bodies, which are arranged in rows that are angularly offset from one another,

FIG. 3A shows a view from behind of a further exemplary optical element,

FIG. 4A shows exemplary light distribution with a switched on first row of light guiding bodies,

FIG. 4B shows exemplary light distribution with a switched on first and second row of light guiding bodies,

FIG. 4C shows exemplary light distribution with a switched on first, second and third row of light guiding bodies, and

FIG. 4D shows exemplary light distribution with a switched on first, second, third and fourth row of light guiding bodies.

FIG. 1 shows an exemplary illumination device 10 for a motor vehicle headlight of a single-track motor vehicle, for example a motorbike, for producing segmented light distribution, wherein the illumination device 10 has an optical element 100, comprising a base body 110 and a plurality of light guiding bodies 200 protruding from the base body 110 for forming definable segmented light distribution from the light of light sources 50.

The light guiding bodies 200 respectively have a light entry surface 210, into which light can be fed from the light sources 50, and an exit surface 220, from which light that can be fed into the respective light guiding body 200 exits, wherein the exit surfaces 220 of adjacent light guiding bodies 200 form a common exit surface 220a, which is curved, of the optical element 100.

Furthermore, the illumination device 10 comprises a plurality of light sources 50, wherein at least one light source is respectively associated with an entry surface 210 of a light guiding body 200, wherein the illumination device 10 further has projection optics 300 with an optical axis A, which projection optics 300 are designed to project the light emitted from the common exit surface 220a in front of the illumination device 10 in the direction of a main emission direction X.

Furthermore, the projection optics 300 have a curved focal surface, wherein the common exit surface 220a of the optical element 100 is arranged in the focal surface of the projection optics 300, wherein the common exit surface 220a follows the curvature of the focal surface of the projection optics 300.

The base body 110 has a first and a second light emission half 110a, 110b, wherein the first light emission half 110a has light guiding bodies 200, which are arranged in a first row R1 along a straight line G1, in a second row R2 along a straight line G2, in a third row R3 along a straight line G3 and in a fourth row R4 along a straight line G4, wherein the straight lines of the first and the second row R1, R2 are arranged relative to each other by a first angular offset W1, wherein the straight lines of the first and third row R1, R3 have a second angular offset W2 with respect to one another, wherein the straight lines of the first and fourth row R1, R4 have a third angular offset W3 with respect to one another, and wherein the first and second light emission halves 110a, 110b are arranged in mirror symmetry to one another about a vertical axis of symmetry V on the base body 110. In this case, the second light emission half 110b also has four rows R1′, R2′, R3′, R4′, which likewise have the corresponding angular offset with respect to one another, like the rows of the first light emission half 110a.

It can be seen in FIG. 2 and FIG. 3 that the exit surfaces 220 of the light guiding bodies 200 of a row R1, R1′, R2, R2′, R3, R3′, R4, R4′ get bigger starting from the vertical axis of symmetry V.

Furthermore, the entry surfaces 210 of the light guiding bodies 200 are arranged in a common vertical plane, which vertical plane is arranged orthogonal to the optical axis A of the projection optics 300.

As also shown in FIG. 2 and FIG. 3, each light guiding body 200 has side walls extending from the entry surface 210 to the exit surface 220, wherein the exit surface 220 is respectively delimited by two narrow sides and two long sides, wherein the side surfaces of at least one light guiding body 200, which side surfaces are orthogonal to a direction transverse to the main emission direction X, are curved, wherein that side surface 230a of the light guiding body 200 that is directed towards the vertical axis of symmetry V is convex, and that side surface 230b of the light guiding body 200 that is directed opposite to the vertical axis of symmetry V is concave.

Furthermore, each row R1, R1′, R2, R2′, R3, R3′, R4, R4′ has an outermost light guiding body arranged away from the vertical axis of symmetry V and at least one inner light guiding body, wherein the at least one inner light guiding body of each row R1, R1′, R2, R2′, R3, R3′, R4, R4′ has the curved side surfaces.

Moreover, the entry surfaces 210 of each light guiding body 200 have a parallel offset from the corresponding exit surface 220 such that the surface centre of the exit surface 220 and the surface centre of the associated entry surface 210 have an offset when viewed in the main emission direction X, as can be seen in FIG. 2 and FIG. 3.

Furthermore, the illumination device 10 comprises a control unit and at least one roll angle sensor, which is designed to determine a roll angle of deviation of the actual position from a defined standard position of the illumination device 10 about the main emission direction X, wherein the control unit is designed to receive a role angle from the at least one roll angle sensor and switch on and/or off individual rows R1, R1′, R2, R2′, R3, R3′, R4, R4′ of the light guiding bodies 200 depending on the roll angle.

FIG. 3 shows a further example of an optical element 100, wherein the optical element 100 comprises, in the area where the two light emission halves converge at the vertical axis of symmetry V, two rows 400 having at least two light guiding bodies, wherein this row 400 is arranged along a straight line, which is arranged orthogonal to the vertical axis of symmetry f. The above also applies to the embodiment in FIG. 3A.

FIGS. 4A, 4B, 4C and 4D respectively show exemplary light distributions, in which a single-track motor vehicle, for example a motorbike, is in a left-hand position or left-hand bend, wherein individual rows of the first light emission half 110a are switched on depending on the roll angle. It should be noted that the above shall also apply to a corresponding right-hand position or right-hand bend.

When a first roll angle is detected, the control unit is designed to activate or switch on the first row R1 of the first or second light emission half 110a, 110b of the optical element 100, as can be seen in FIG. 4A, and wherein when a second roll angle is detected, the control unit is designed to activate or switch on the first and second row R1, R2 of the first or second light emission half 110a, 110b of the optical element 100, as can be seen in FIG. 4B.

Furthermore, when a third roll angle is detected, the control unit is designed to activate or switch on the first, second and third row R1, R2, R3 of the first or second light emission half 110a, 110b of the optical element 100, as can be seen in FIG. 4C, and wherein when a fourth roll angle is detected, the control unit is designed to activate or switch on the first, second, third and fourth row R1, R2, R3, R4 of the first or second light emission half 110a, 110b of the optical element 100, as can be seen in FIG. 4D.

The first roll angle is in a range of 5° to 7°, the second roll angle is in a range of 7° to 17°, the third roll angle is in a range of 17° to 27° and the fourth roll angle is in a range over 27°.

### REFERENCE LIST

Illumination device . . . 10
Light sources . . . 50
Optical element . . . 100
Base body . . . 110
First light emission half . . . 110a
Second light emission half . . . 110b
Light guiding body . . . 200
Entry surface . . . 210
Exit surface . . . 220
Common exit surface . . . 220a
Projection optics . . . 300
Optical axis . . . A
Main emission direction . . . X
Vertical axis of symmetry . . . V
Angular offset . . . W1, W2, W3
Rows . . . R1, R2, R3, R4, 400
Straight lines . . . G1, G2, G3, G4

1. An illumination device (10) for a motor vehicle headlight of a single-track motor vehicle for producing segmented light distribution, the illumination device (10) comprising:
an optical element (100), comprising a base body (110) and a plurality of light guiding bodies (200) protruding from the base body (110) for forming definable segmented light distribution from the light of light sources (50), which light guiding bodies (200) respectively have a light entry surface (210), into which light can be fed from the light sources (50), and an exit surface (220), from which light that can be fed into the respective light guiding body (200) exits, wherein the exit surfaces (220) of adjacent light guiding bodies (200) form a common exit surface (220a) of the optical element (100),
a plurality of light sources (50), wherein at least one light source is respectively associated with an entry surface (210) of a light guiding body (200),
projection optics (300) with an optical axis (A), which projection optics (300) are designed to project the light emitted from the common exit surface (220a) in front of the illumination device (10) in the direction of a main emission direction (X),
wherein the base body (110) has a first and a second light emission half (110a, 110b), wherein each light emission half (110a, 110b) has light guiding bodies (200), which are arranged at least in a first row (R1) along a straight line and in a second row (R2) along a straight line, wherein the straight lines of the first and the second row (R1, R2) are arranged relative to each other by a first angular offset (W1), and wherein the first and second light emission halves (110a, 110b) are arranged in mirror symmetry to one another about a vertical axis of symmetry (V) on the base body (110).

2. The illumination device according to claim 1, wherein the exit surfaces (220) of the light guiding bodies (200) of a row (R1, R2) get bigger starting from the vertical axis of symmetry (V).

3. The illumination device according to claim 1, wherein the entry surfaces (210) of the light guiding bodies (200) are arranged in a common vertical plane, which vertical plane is arranged orthogonal to the optical axis (A) of the projection optics (300).

4. The illumination device according to claim 1, wherein the common exit surface (220a) of the optical element (100) is curved.

5. The illumination device according to claim 1, wherein the projection optics (300) have a curved focal surface, wherein the common exit surface (220a) of the optical element (100) is arranged in the focal surface of the projection optics (300), wherein the common exit surface (220a) follows the curvature of the focal surface of the projection optics (300) at least in sections.

6. The illumination device according to claim 1, wherein each light guiding body (200) has side walls extending from the entry surface (210) to the exit surface (220), wherein the exit surface (220) is respectively delimited by two narrow sides and two long sides, wherein the side surfaces of at least one light guiding body (200), which side surfaces are orthogonal to a direction transverse to the main emission direction (X), are curved, wherein that side surface of the light guiding body (200) that is directed towards the vertical axis of symmetry (V) is convex, and that side surface of the light guiding body (200) that is directed opposite to the vertical axis of symmetry (V) is concave.

7. The illumination device according to claim 6, wherein each row (R1, R2) has an outermost light guiding body arranged away from the vertical axis of symmetry (V) and at least one inner light guiding body, wherein the at least one inner light guiding body of each row (R1, R2) has the curved side surfaces.

8. The illumination device according to claim 1, wherein the optical element comprises, in the area where the two light emission halves converge at the vertical axis of symmetry (V), at least one row (400) having at least two light guiding bodies, wherein this row (400) is arranged along a straight line, which is arranged orthogonal to the vertical axis of symmetry (V).

9. The illumination device according to claim 1, wherein the entry surfaces (210) of each light guiding body (200) have a parallel offset from the corresponding exit surface (220) such that the surface centres of the exit surface (220) and the associated entry surface (210) have an offset when viewed in the main emission direction (X).

10. The illumination device according to claim 1, wherein the illumination device (10) comprises a control unit and at least one roll angle sensor, which is designed to determine a roll angle of deviation of the actual position from a defined standard position of the illumination device (10) about the main emission direction (X), wherein the control unit is designed to receive a role angle from the at least one roll angle sensor and switch on and/or off individual rows (R1, R2) of the light guiding bodies (200) depending on the roll angle.

11. The illumination device according to claim 10, wherein when a first roll angle is detected, the control unit is designed to activate or switch on the first row (R1) of the first or second light emission half (110a, 110b) of the optical element (100), and wherein when a second roll angle is detected, the control unit is designed to activate or switch on the first and second row (R1, R2) of the first or second light emission half (110a, 110b) of the optical element (100).

12. The illumination device according to claim 1, wherein the optical element (100) comprises a third row (R3) of light guiding bodies (200), which has a second angular offset from the first row (R1) and is arranged symmetrically about the vertical axis of symmetry (V), and wherein the optical element (100) comprises a fourth row (R4) of light guiding bodies, which has a third angular offset from the first row (R1) and is arranged symmetrically about the vertical axis of symmetry (V).

13. The illumination device according to claim 12, wherein when a third roll angle is detected, the control unit is designed to activate or switch on the first, second and third row (R1, R2, R3) of the first or second light emission half (110a, 110b) of the optical element (100), and wherein when a fourth roll angle is detected, the control unit is designed to activate or switch on the first, second, third and fourth row (R1, R2, R3, R4) of the first or second light emission half (110a, 110b) of the optical element (100).

14. The illumination device according to claim 1, wherein the segmented light distribution is segmented full beam distribution or dipped beam distribution.

15. A motor vehicle headlight having at least one illumination device (10) in accordance with claim 1.

16. The illumination device according to claim 8, wherein the optical element comprises two rows (400).
